(19) United States
(12) Patent Application Publication
(10) Pub. No.: US 2013/0247551 A1
(43) Pub. Date: Sep. 26, 2013

(54) Centrifugal force harnessing system and power generation method

(71) Applicant: John Charles Heiss, Williams, AZ (US)

(72) Inventor: John Charles Heiss, Williams, AZ (US)

(21) Appl. No.: 13/506,075

(22) Filed: Mar. 26, 2012

(51) Int. Cl. F03B 7/00; H02K 53/00

(52) U.S. Cl. 60/327; 415/916

(57) ABSTRACT

The disclosed invention is a description of the means to create a condition in which liquid matter (water as shown) is subjected to centrifugal force induced by rotating the water as it is circulated in a confined system at velocities sufficient to generate electrical power. The power generated by the system is used to maintain rotation of the entire system, continuously circulate the water within the rotating system and to deliver the surplus electrical energy for discretionary use.

### BACKGROUND OF THE INVENTION

1. Technical Field

The present invention relates to creating and efficiently sustaining a condition in which a liquid mass such as water is subjected to centrifugal force while under rotation and to harness the force of the water for purposes of generating electrical energy.

2. Background Art

There have been previous attempts to harness the rotational kinetic energy in mass due to the effects of centrifugal force that result during the circular movement of mass around a fixed axis. All previous attempts to harness this effect have failed due to the laws expressed in the conservation of angular momentum theorem. Accordingly, the energy required to accelerate mass as it moves outwardly from the center of rotation is exactly equal to the potential rotational kinetic energy available in the mass once it reaches an outer orbit. As a result, under previous models, no energy could be extracted from the system without reducing the angular momentum of the mass. Any energy removed would require the input of an equal amount of energy in order to restart the process.

However, the embodiment described herein resolves this basic problem by exploiting the properties gravity has on liquid mass such as water. By design, the system extracts energy from the rotational kinetic energy in the water at the exterior radius of the rotating system as it passes through a hydro electric turbine. Unlike other approaches, no angular momentum in the system is lost as gravity continuously returns the fast moving water on the outer radius to an inward radius location as it is constantly circulated by a pumping mechanism. Because the angular momentum of the fast moving water is conserved and transferred to the rotating system as it is pulled inwardly by gravity, only a relatively small amount of energy is required to overcome roll and air friction to maintain rotational velocity. In addition, because gravity returns the water inwardly to a pump, nominal energy is required to sustain the circulation of the water.

Notwithstanding entropy in the form of mechanical friction, air resistance and water turbulence, the operation of the system is self-sustaining. The system can serve as a source of inexpensive and clean energy. Unlike other forms of alternative energy, it is not subject to the inherent limitations such as the availability of wind, sunshine, wave activity or falling water. It can also be used in space by systematically providing for a rotationally induced gravitational field perpendicular to the rotation of the system. Moreover, unlike fossil fueled power plant systems, there are no green house gases or other pollutants. In addition, the system lends itself to a wide array of sizes and capacities. Increasing the vertical distance between the bottom of the platform and the mounted height of the turbines, requires a faster rotational speed to reach and maintain the elevated height of the water column at the discharge point of the turbine levels due to the resulting higher water pressure at the bottom of the water column. This in turn results in an increased energy output in relationship to the marginally higher energy input levels necessary to to pump the water to a higher level and to maintain the faster rotational velocity of the platform assembly. Thus the system may be built on a small scale with the capability of supplying the needs of an individual home, or on a larger scale approximating the output of a coal fired plant. Although described herein is a system comprised of two, identically constructed devices mounted on a single platform, two or more pairs could conceivably be located on the same platform, thus reducing the power output to foot print ratio.

### SUMMARY

The present invention relates to the development of a system that exploits the characteristics of water or other liquids when subjected to the centrifugal force induced by rotation. Under these conditions, water may be pumped vertically by a pump situated inwardly on a rotating platform. By design, the pump is positioned so that during operation, it is constantly immersed in water. Accordingly, the energy required to elevate the water is negligibly affected by the rotation of the platform as the pump does not have to pull the water inwardly against the influence of centrifugal force. Furthermore, the discharge point of the water being pumped upwardly is located at a radius external to the position of the pump whereby the acceleration of the water moving outwardly assists in the circulatory action. As the water reaches an upper section of horizontal pipe, it accelerates outwardly due to centrifugal force as it passes through a hydro electric turbine installed within the outer portion of pipe. At this outward location, the water exerts pressure enhanced by the effects of rotation on the turbine and therefore generates more energy than is required to elevate it vertically by the inwardly positioned pump. After passing through the turbine and an air gap, the water is returned to the pump by gravity. By establishing and maintaining a constant rotational velocity of the entire assembly to achieve the aforementioned conditions, the circulating liquid mass remains constant at all times along the radius of the rotating platform. The mass of water rotating at a higher velocity on the outer radius of the system is pulled down and inwardly by gravity and offsets the mass of the slower moving water circulating outwardly. As a result, the system does not require additional energy to maintain rotational velocity and thus has the potential to produce energy in excess of operational requirements. A more detailed description of the particular embodiments of the invention is illustrated in the accompanying drawings. It should be noted that opposing pairs of components are installed as illustrated to ensure the system is balanced during operation. In addition, a plurality of opposing pairs may be mounted on a single, rotating platform.

### BRIEF DESCRIPTION OF DRAWINGS

FIG. 1 is a side view of the embodiment revealing the cover shield with affixed linear synchronous motor apparatus and bearing assembly.

FIG. 2A is a cross sectional view of the complete embodiment

FIG. 2B is a more detailed view of one half of the embodiment

FIG. 3 A is the view of the underside of the cover shield depicting the rotating electrical connecter mounted in the center of the assembly used to deliver power to the grid.

FIG. 3B is a view of the bottom of the rotating platform revealing the rotating electrical connector mounted in the center to deliver power to the pump.

### DETAILED DESCRIPTION OF THE EMBODIMENTS OF THE INVENTION

For purposes of clarity, specific terms are used in the following description of the drawings but are not intended to define or limit the possible types of materials to be used or the location of components within the embodiment or limit the scope of the invention. In addition, the drawings are not to scale but provide a general relationship between the height and width of the apparatus and the relative location of the components within.

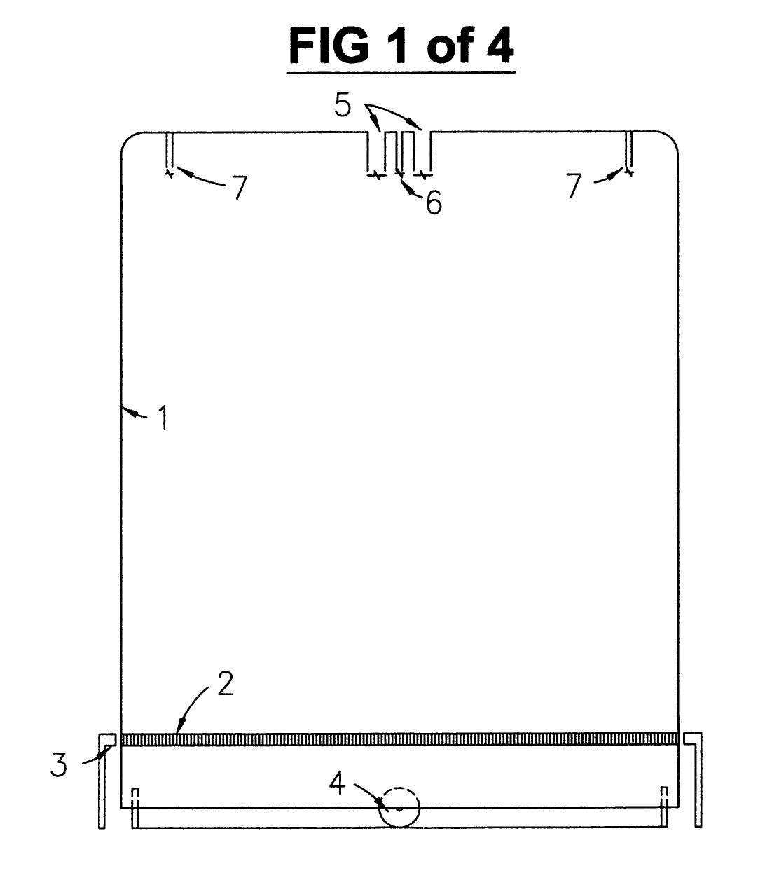

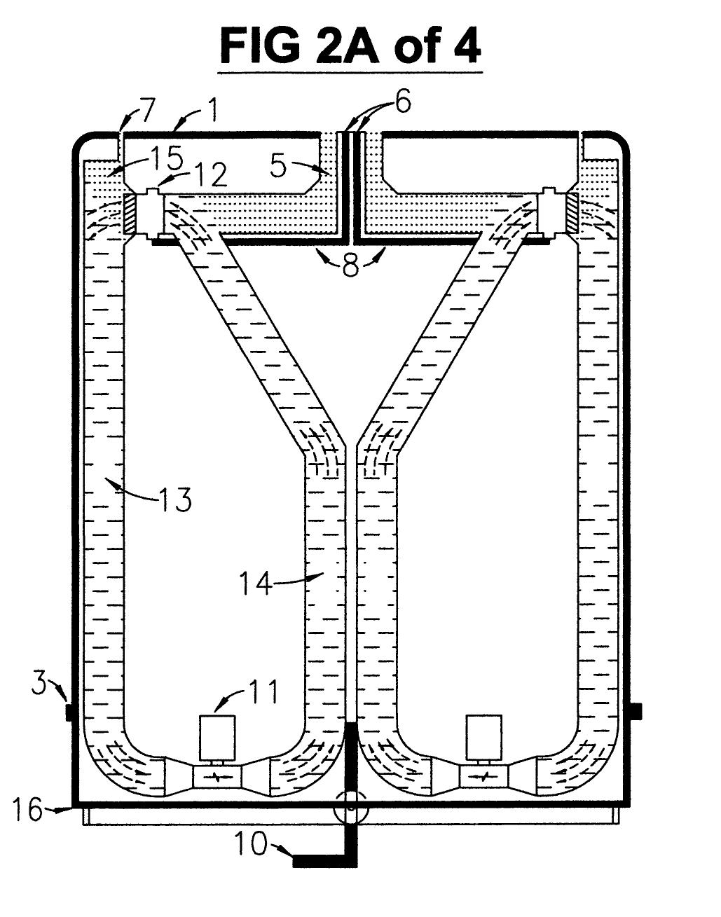

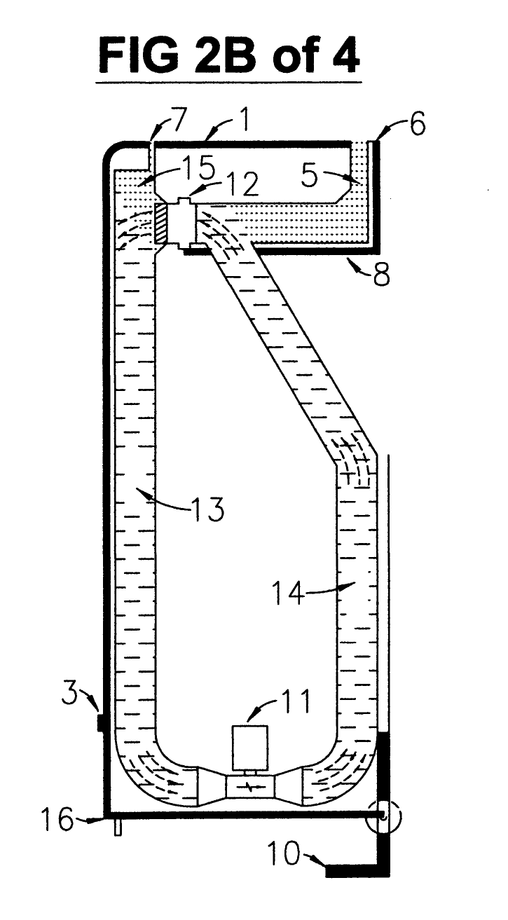

With reference to the drawings, FIG. 1, a cover shield (1) envelopes the entire assembly to reduce air resistance during rotation. The rotor component of a linear synchronous motor (2) is installed on the outer circumference of the cover shield positioned in alignment with the ground mounted stator component (3) of the motor encircling the system. The entire rotating apparatus is mounted upon a system of wear resistant, low friction bearings (4). At the top of the cover shield is the center mounted fill tube (5) for adding water. In the middle of the fill tube is a rotating electrical connector (6) which is designed to transmit power from the system to the grid during operation. At opposing sides of the top of the cover shield are air vents (7) which relieve air pressure as water is added to the system and to create an air gap (15) for water as it passes through the turbines (12) depicted in FIGS. 2 A and B.

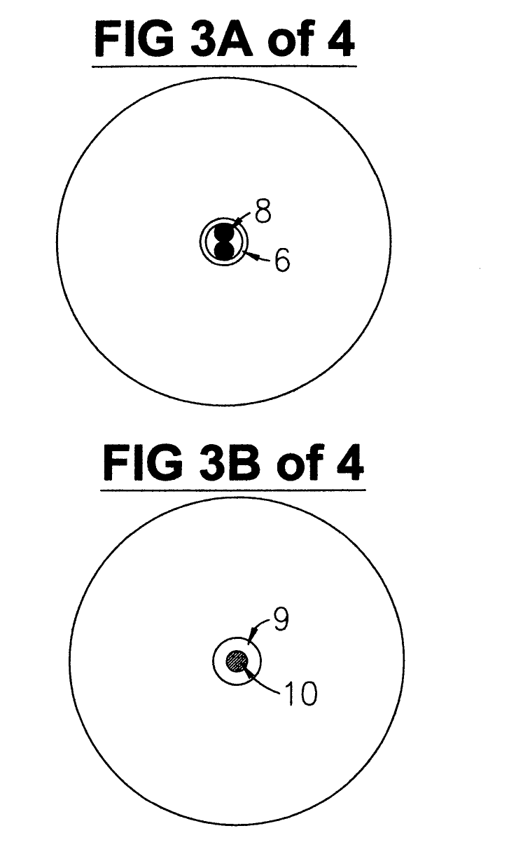

FIG. 2 A, and in more detail in FIG. 2 B, reveal a cross sectional view of the internal components of the system during the actual operation. As the rotational velocity of the platform (16) is increased by the linear synchronous motor as shown in FIG. 1, water is continually added to ensure the pump (11) is always submerged and to maintain the height of the water column inside the outermost section of pipe (13) so that the column extends upwards to the discharge point of the turbine (12). Once this occurs, the variable speed pump (11) is engaged as additional water is added to the system through the fill tube (6) until the water column passing through the inwardly mounted, vertical section of smaller diameter pipe (14) reaches the turbine (12). At this occurrence, the turbine (12) is engaged and simultaneously, the capacity of the variable speed pump (11) is adjusted to match the discharge rate from the turbine (12) as the input of water is concluded and the rotational speed provided by the linear synchronous motor (3) is set to maintain the conditions as depicted in the drawing. Electrical current generated by the turbine (12) is transmitted by insulated electrical cable (8) through the rotating electrical connector (5). FIG. 3 A of 4 identifies the position of the rotating electrical connector (6) located at the top center of the cover shield. This connector is affixed to the shield and thus rotates at the same rate as the entire system as it transmits power through the stationary component of the connector suspended outside and above the rotating system (not depicted).

A portion of the electrical energy generated by the turbine is transmitted to a power grid, while some is diverted to the linear synchronous motor to maintain the proper rotational velocity and to supply power to the pump through the rotating electrical connector illustrated in FIG. 3 B of 4 (9). This rotating electrical connector device is located in the center of the bottom platform of the system and rotates at the same rate as the entire system. Electrical current is transmitted through the cable (10) which is interconnected to the ground mounted, stationary component of the rotating electrical connector situated beneath the system (not depicted).

### Engineering Assumptions and Potential Modifications:

The liquid in the embodiment is water
Substantial infrastructure to amount and suspend the internal components of the system are incorporated into the overall design (not depicted in drawings)
The gas in the system is air
The ambient temperature during operation is 72 degrees Fahrenheit
The system can be constructed to various scales and of various and alternative materials
When engaged, a constant electrical demand is placed on the generator so as to achieve a steady discharge of water to match the quantity supplied by the pump
The rotational velocity of the entire assembly is calibrated and maintained to achieve a water column that extends upwardly to but not beyond the discharge point of the turbines

The embodiments and examples set forth herein were presented in order to best explain the present invention and its practical application. It is understood that those of ordinary skill in the art will recognize that the description presented herein is presented for purposes of illustration and example and the description set forth is not intended to be exhaustive or to limit the invention to the precise form disclosed. It is possible to construct numerous variations of the teachings presented without departing from the spirit and scope of the forthcoming claims. Among the contemplated modifications include, but are not limited to:
Incorporating multiple generating systems on a single rotating platform
Designing the turbines so as to most efficiently harness the rotational kinetic energy of the circulating water
Suspending the entire system by magnetic levitation or on various other load bearing assemblies to minimize roll friction
Placing the entire system in a vacuum to reduce air friction
Use of liquids and gases other than water or air
Providing means other than rotating electrical connectors for the purpose of transmitting power to the pumps and from the generators
Application of the system in outer space by creating and maintaining a centrifugally induced gravitational field perpendicular to the rotation of the system herein described

1. A method to create a condition in which a liquid such as water is subjected to continual centrifugal force while contained in vessels mounted on a rotating platform.

2. A method to harness the force of the water by passing it through a hydro-electric turbine mounted at the outer radius of the rotating platform.

3. A method to return the water downwardly and inwardly to a pump. The rotational kinetic energy inherent in the returning water serves to continually accelerate the rotating platform which limits the energy input demand to maintain the rotational velocity of the platform to simply overcome air and roll friction.

4. A method to pump the water upwardly while under rotation to constantly deliver it to the hydro-electric turbine.

5. A method to provide electrical energy to the rotating platform and pump while under rotation.

6. A method to extract electrical energy from the hydro-electric turbine and make it available to maintain the generating process and for other electrical energy purposes.
